(19) United States
(12) Patent Application Publication
(10) Pub. No.: US 2007/0278404 A1
(43) Pub. Date: Dec. 6, 2007

(54) Radiometric Measuring Device

(75) Inventors: Dietmar Spanke, Steinen (DE); Holger Steltner, Esslingen (DE); Peter Fabrice, Blotzheim (FR); Bernhard Ottenbreit, Schworstadt (DE)

Correspondence Address: BACON & THOMAS, PLLC, 625 SLATERS LANE, FOURTH FLOOR, ALEXANDRIA, VA, 22314, US

(73) Assignee: Endress + Co. KG, Maulburg (DE)

(21) Appl. No.: 10/589,578

(22) PCT Filed: Feb. 14, 2005
(86) PCT No.: PCT/EP05/50639

§ 371 Date: Jun. 27, 2007

(30) Foreign Application Priority Data
Feb. 16, 2004 (DE) 10 2004 007 680.4

(51) Int. Cl. G21H 5/02

(52) U.S. Cl. 250/303

(57) ABSTRACT

A radiometric measuring device for mounting at a container fillable with a filling substance. The measuring device, which is cost-favorable both in installation and operation, includes: A radioactive source, which, during operation, sends radioactive radiation through the container; at least two detectors, which serve for registering radiation passing through the container and for producing electrical pulse rates corresponding to the registered radiation; wherein the detectors are connected together and with a superordinated unit by a single line running outside of the detectors. The pulse rates and, in the form of offsets, status of the detectors are transmitted on the single line.

The invention relates to a radiometric measuring device. By means of radiometric measuring devices, physical variables, e.g. a fill level or a density of a medium, are measurable.

Radiometric measuring devices are usually always applied, when conventional measuring devices can not be used at the measuring site, because of especially rough conditions. Very frequently, e.g. extremely high temperatures and pressures reign at the measuring site, or chemically and/or mechanically very aggressive, environmental influences are present, which make the use of other measuring methods impossible.

In radiometric measurement technology, a radioactive source, e.g. a Co 60 or a Cs 137 preparation, is placed in a radiation protection container and brought to a measuring location, e.g. to a container filled with a filling substance. Such a container can be e.g. a tank, a pipe, a conveyor belt or any other possible form of containment.

The radiation protection container has a window, through which the radiation emitted by the source positioned for the measurement is radiated out, through a wall of the radiation protection container.

Usually, a radiating direction is selected, such that the radiation passes through that region of the container which is to be registered for measurements. On the oppositely lying side, emerging radiation intensity changed by a fill level, or density, change is quantitatively registered with a detector. The emerging radiation intensity is dependent on the geometric arrangement and on the absorption. The latter is, in the case of fill level measurements, dependent on the amount of filling substance in the container, and, in the case of density measurements, on the density of the filling substance. As a result, the emerging radiation intensity is a measure for the current fill level, or the current density, of the filling substance in the container.

Suitable as detectors are e.g. a scintillation detector having a scintillator, e.g. a rod-shaped scintillation probe, and a photomultiplier. The scintillation probe is, in principle, a Plexiglas rod, which is optically very pure. Under the influence of gamma radiation, light flashes are emitted by the scintillation material. These are registered by the photomultiplier and converted into electrical pulses. A pulse rate, with which the pulses occur, depends on the radiation intensity and is, therefore, a measure for the physical variable to be measured, e.g. the fill level or the density. Scintillators and photomultipliers are usually assembled into a protective tube e.g. of a high grade steel, e.g. a high grade, stainless steel.

The detector includes, as a rule, an electronics, which makes available to a superordinated unit an output signal corresponding to the pulse rate. The electronics includes, usually, a control unit and a counter. The electrical pulses are counted and a count rate is derived, on the basis of which the physical variable to be measured is determinable.

Additionally, preferably a status of the detector is checked. The status involves, in the simplest case, an indication concerning whether the detector is working properly or not. Depending on the status, as required, a malfunction report and/or an alarm is triggered.

For transmitting the output signal and status of a detector, as a rule, two lines are provided between the detector and the superordinated unit.

An effective length of the detectors determines the measurable range of the container and depends on the required measurement height and the mounting opportunities. Detectors are obtainable, at this time, in lengths of about 400 mm to about 2000 mm. If a length of about 2000 mm is not sufficient, then two or more detectors can be connected to a radiometric measuring device.

A feature of conventional measuring devices is that each detector has its own electronics. For transmitting the output signals and status of each detector, at least two lines are run from each detector to the superordinated unit. The output signals of individual detectors are combined in the superordinated unit to a sum signal, which reflects the total rate of the registered pulses.

In the application of two or more detectors, the required technical effort rises in proportion to the number of detectors. For each detector, its own electronics is to be provided, with a counter and a control unit, the status of each detector must be separately checked, and each detector is to be connected with the superordinated unit by means of two lines. The superordinated unit must then check the status of each detector and combine the individual output signals to a measurement signal.

Each additional line increases the costs. Especially, when the detectors are placed in explosion-endangered areas, the costs for additional lines are considerable.

It is an object of the invention to provide a radiometric measuring device having two or more detectors, which can be installed and operated cost-favorably.

To this end, the invention involves a radiometric measuring device for mounting at a container fillable with a filling substance, including
a radioactive source, which, in operation, sends radioactive radiation through the container,
at least two detectors,
   which serve for registering radiation passing through the container and for producing an electrical pulse rate corresponding to the registered radiation,
offset generators, which superimpose on the pulse rate of each detector an offset representing a status of such detector, and
a collector line,
   to which each detector feeds an output signal corresponding to the superimposing of its pulse rate and its offset,
   which feeds to a superordinated unit a sum signal corresponding to the superimposing of the output signals,
      with the superordinated unit deriving, on the basis of the sum signal, a measurement signal and/or a status of the measuring device.

Further, the invention involves a radiometric measuring device for mounting at a container fillable with a filling substance, including
a radioactive source, which, in operation, sends radioactive radiation through the container,
at least two detectors,
   which serve for registering radiation passing through the container and for producing an electrical pulse rate corresponding to the registered radiation,
offset generators, which superimpose on the pulse rate of each detector a detector-specific offset, and
turn-off switches, which serve for suppressing transmission of pulse rate and offset, when a detector malfunctions,
a collector line,
   to which each properly working detector feeds an output signal corresponding to the superimposing of its pulse rate and its offset, and
   which feeds to a superordinated unit a sum signal corresponding to the superimposing of the output signals,
      with the superordinated unit deriving, on the basis of the sum signal, a measurement signal and/or a status of the measuring device.

According to an embodiment of the above-defined, radiometric measuring device, a series of detectors is provided, and the collector line begins at a first detector of the series, leads from there from one detector to the detector neighboring such, and from the last detector to the superordinated unit.

In a further embodiment, each detector comprises a scintillator and a photomultiplier appended thereto.

According to a further development of the last-mentioned, radiometric measuring device, the offset-generators send periodic reference light flashes through the scintillator via a light conductor.

In a further embodiment, the superordinated unit is integrated in the last detector of the series.

The invention further resides in a method for measuring a physical variable with one of the above-defined, radiometric measuring devices, wherein
a desired value for an offset is assigned to each detector, the offset generators of the detectors generate the desired value when the detector is working properly, and the desired value is greater than a sum of the maximum expected pulse rates for the detectors, and wherein
the superordinated unit determines a total count rate on the basis of the sum signal,
forms the difference between this total count rate and a count rate corresponding to the sum of the desired values of the offsets,
recognizes that an error is present, when the difference is negative, and
in the case of positive difference, derives a measurement signal.

According to an embodiment of the method, in the case of a negative difference, it is determined on the basis of the amount of the difference, which of the detectors is malfunctioning.

Further, the invention resides in a radiometric measuring device for mounting at a container fillable with a filling substance, comprising
a radioactive source, which, during operation, sends radioactive radiation through the container,
first and second detectors,
   which serve for registering radiation passing through the container and for producing an electric pulse rate corresponding to the registered radiation,
an offset-generator, which superimposes on the pulse rate of the first detector an offset reflecting a status of the first detector, and,
integrated in the second detector, a superordinated unit,
   with which the first detector is connected via a connecting line,
      via which the first detector feeds an output signal corresponding to the superpositioning of the pulse rate and the offset,
   to which the pulse rate and a status of the second detector are fed, and
   which, on the basis of the incoming signals, derives a measurement signal and/or a status of the measuring device.

Further, the invention resides in a radiometric measuring device for mounting at a container fillable with a filling substance, comprising
a radioactive source, which, during operation, sends radioactive radiation through the container,
first and second detectors,
   which serve for registering radiation passing through the container and for producing an electric pulse rate corresponding to the registered radiation and for transmitting an output signal corresponding to the pulse rate to a superordinated unit integrated in the second detector,
wherein the source has a strength, in the case of which, for each detector, always a minimum pulse rate greater than zero is to be expected,
wherein, in each detector, a turn-off switch is provided, which suppresses transmission of the output signal to the superordinated unit, when the detector is malfunctioning, and
wherein the superordinated unit derives a measurement signal and/or a status of the measuring device on the basis of the output signals.

An advantage of the invention is that the detectors are only connected by a single line, the collector line, or the connecting line, as the case may be, via which both the status information and the measurement information are transmitted, because a single output signal is produced, which contains both pieces of information. This happens by superimposing a status-dependent offset on the pulse rate, or by superimposing on the pulse rate a detector-specific offset dependent on status, or this does not happen.

The invention and further advantages will now be explained in greater detail on the basis of the figures of the drawing, in which seven examples of embodiments are presented; equal parts are provided in the figures with equal reference characters. The figures show as follows:

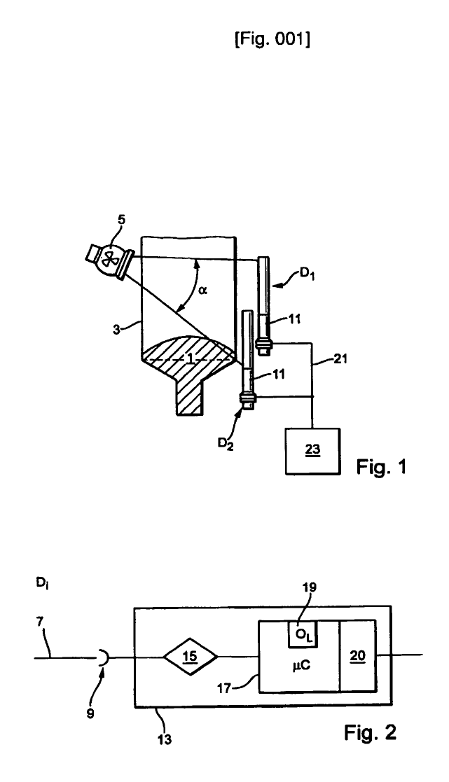

FIG. 1 schematically, a container-mounted, radiometric, measuring device having two detectors;

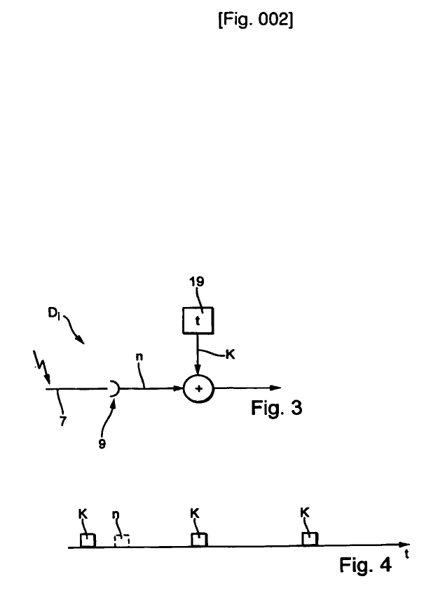

FIG. 2 schematically, the construction of a detector;

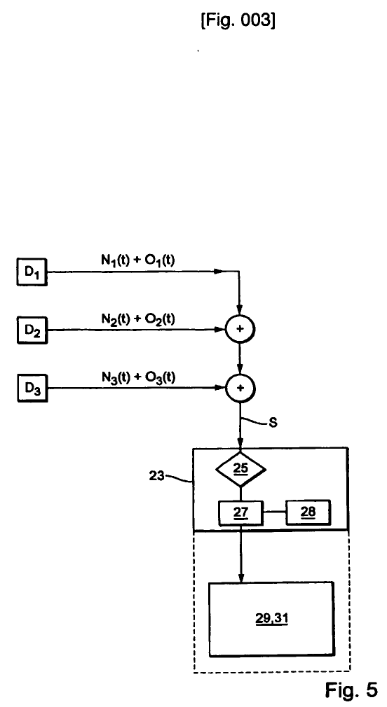

FIG. 3 schematically, a superimposing of pulse rate and offset;

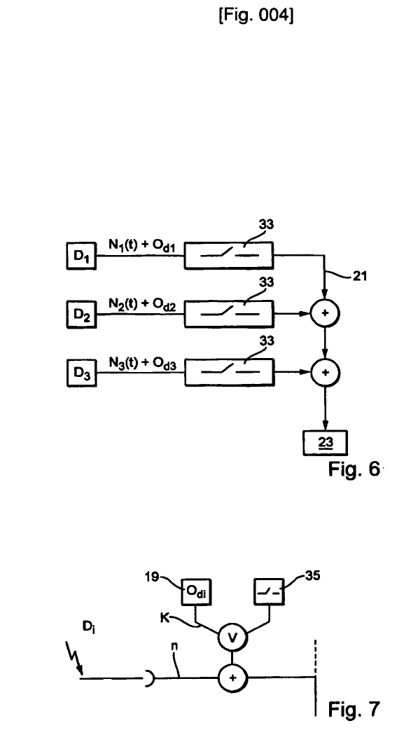

FIG. 4 a signal corresponding to the superimposing of FIG. 3;

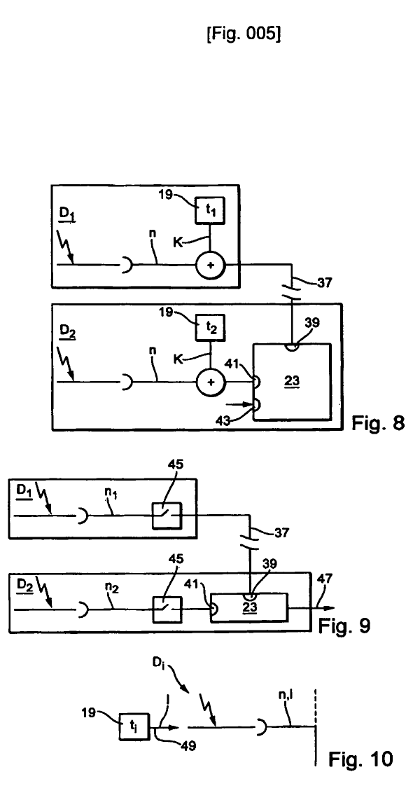

FIG. 5 schematically, the construction of a measuring device having three detectors, wherein, on the pulse rate of each detector is superimposed an offset dependent on the status of the detector;

FIG. 6 schematically, the construction of a measuring device having three detectors, wherein a detector-specific offset is superimposed on the pulse rate of each detector;

FIG. 7 schematically, the construction of a detector, wherein, depending on the status of the detector, an offset generator for producing a detector-specific offset, or a turn-off switch, is used;

FIG. 8 schematically, the construction of a measuring device having two detectors, wherein at least one detector has an offset generator, which superimposes on the pulse rate of the detector an offset depending on the status of the same;

FIG. 9 schematically, the construction of a measuring device having two detectors, each of which has a turn-off switch, which suppresses transmission of the pulse rate when the relevant detector is not working properly; and

FIG. 10 the construction of a detector having an offset generator, which feeds reference light flashes to the scintillator.

FIG. 1 shows, schematically, a measuring arrangement with a radiometric measuring device. The measuring arrangement includes a container 3 fillable with a filling substance 1. The radiometric measuring device is mounted at the container 3 and serves for registering a physical variable, e.g. a fill level of the filling substance 1 in the container 3, or a density of the filling substance 1.

To this end, the radiometric measuring device includes a radioactive source 5, which sends radioactive radiation through the container 3 during operation. Source 5 includes e.g. a radiation protection container, in which is housed a radioactive preparation, e.g. a Co 60 or Cs 137 preparation. The radiation protection container has a window, through which the radiation emerges at a spreading angle α and passes through the container 3.

The measuring device further includes at least one detector D, which serves for registering the radiation passing through the container 3 and for producing an electric pulse rate N corresponding to the registered radiation. Depending on application, a plurality of detectors Dᵢ can be connected one after the other, in order to cover a sufficiently large range, in which radiation can be registered. In the example of an embodiment shown in FIG. 1, two detectors D₁ and D₂ are provided.

FIG. 2 shows a simplified construction of a detector Dᵢ. In this case, a scintillation detector is shown, with a scintillator 7, here a rod-shaped scintillation probe, and a photomultiplier 9 appended thereto. Scintillator 7 and photomultiplier 9 are located in a protective tube 11 shown in FIG. 1, for instance a protective tube of high-grade steel, for example a stainless, high-grade steel. Tube 11 is mounted on an outer wall of container 3. The outer wall lies opposite to the source 5. The rod-shaped scintillation probe is, in principle, a rod of Plexiglas material of optically very high purity. Radiation impinging on the scintillator 7 produces light flashes in the scintillation material. These are registered by the photomultiplier 9 and converted into electrical pulses n.

Each detector Dᵢ includes an electronics 13, which registers electrical pulses n produced by the photomultiplier 9 and produces a pulse rate N corresponding to the registered radiation.

The electronics 13 includes, preferably, a counter 15 and a microcontroller 17 connected thereto. The counter 15 counts the incoming electric pulses n and the microcontroller 17 determines, on the basis of the counted pulses n, a pulse rate N.

According to a first form of embodiment, each detector Dᵢ has, additionally, an offset-generator 19, which produces an offset Oᵢ corresponding to a status of the particular detector Dᵢ. The offset generators 19 are, preferably, and as shown in FIG. 2, integrated into the microcontroller 17. Suitable as offset generator 19 is e.g. a pulse generator, which produces electrical pulses K with a frequency corresponding to the offset Oᵢ. The offset Oᵢ is superimposed on the pulse rate Nᵢ of the relevant detector Dᵢ. FIG. 3 shows such a superimposing schematically. In such case, the pulses K produced by the offset generator 19 are added to the electrical pulses n registered by the photomultiplier 9. An output signal corresponding to the superimposing is shown in FIG. 4, where the pulses K of the offset generator 19 are shown as rectangular pulses. The pulses n of the photomultiplier 9 are likewise shown as rectangular pulses. For distinguishing between the two different kinds of pulses, dashed lines have been used to show the pulses n of the photomultiplier 9.

The output signal is generated in the microcontroller 17 and is available via an output stage 20 of the microcontroller 17.

A collector line 21 is provided, to which each detector Dᵢ feeds its output signal corresponding to the superimposing of its pulse rate Nᵢ and its offset Oᵢ.

The collector line 21 leads from one detector Dᵢ to the next, neighboring detector Dᵢ₊₁. FIG. 5 shows an example of an embodiment having a series of three detectors D₁, D₂ and D₃ connected one after the other. The connecting line 21 begins at the first detector D₁ of the series. It leads from each detector Dᵢ to the neighboring detector Dᵢ₊₁ of the series and ends at the last detector of the series. In FIG. 5, this is detector D₃. From the last detector D₃, it leads to a superordinated unit 23.

In the collector line 21, the output signals of the individual detectors Dᵢ superimpose to form a sum signal S, which corresponds to the sum of the individual output signals.

The superordinated unit 23 derives, on the basis of the sum signal S, a measurement signal M and/or a status signal of the measuring device. To accomplish this, various methods can be used.

A first method will now be explained in greater detail on the basis of the example of an embodiment shown in FIG. 5 as follows. In such case, a desired value Oₛᵢ for the offset Oᵢ is assigned to each detector Dᵢ. The desired values Oₛᵢ are to be so selected, that they are greater than a sum of the maximum pulse rates Nᵢ^{max} to be expected for the respective detectors Dᵢ.
Oₛᵢ>ΣᵢNᵢ^{max}

If the maximum expected pulse rate Nᵢ^{max} of each detector Dᵢ is, for example, smaller than 20 pulses n per interval of time, then the desired values Oₛᵢ in the example of FIG. 5 are to be chosen to be greater than 60 pulses K per interval of time.

In the simplest case, the offset generators 19 of the detectors Dᵢ are made to produce a offset Oᵢ which corresponds to the desired value Oₛᵢ, when the particular detector Dᵢ is working properly, and no offset, i.e. an offset of 0 pulses K per interval of time, when the detector Dᵢ is not working properly.

The superordinated unit 23 contains a counter 25 and an evaluating unit 27 connected thereto. The counter 25 counts the incoming pulses nᵢ, Kᵢ. On the basis of the sum signal, a total count rate G is determined. The total count rate G is equal to the sum of the individual pulse rates Nᵢ of the individual detectors Dᵢ and the individual offsets Oᵢ.

The following holds:
G=Σᵢ(Nᵢ+Oᵢ)

In a next step, the evaluating unit 27 of the superordinated unit 23 forms a difference between this total count rate G and a count rate corresponding to the sum of the desired values Oₛᵢ of the offsets Oᵢ. For this purpose, there is connected to the evaluating unit 27 a memory 28, in which the desired values Oₛᵢ of the offsets Oᵢ are stored.

The following holds:
D=G−ΣᵢOₛᵢ

When all detectors are working properly, this difference is positive and equal to the sum of the pulse rates Nᵢ of the individual detectors Dᵢ.

If at least one detector Dᵢ is not working properly, the difference D is negative. A negative difference D means that an error is present. At least one of the detectors is not working properly.

The evaluating unit 27 determines, whether the difference D is positive or negative. It recognizes that an error is present, when the difference D is negative.

Additionally, it is possible, in the case of the presence of a negative difference D, i.e. an error, on the basis of the magnitude, or absolute value, |D| of the difference D, to determine, which of the detectors Dᵢ is malfunctioning. This makes a search for the error easier, following recognition of the error, as well as facilitating the eliminating of the error.

For this, for instance in the example of an embodiment presented with respect to FIG. 5, all desired values Oₛᵢ of the offset Oᵢ are so selected, that they differ from one another, and the difference of each pair of desired values Oₛᵢ is, in each case, greater than the sum of the maximum pulse rates Nᵢmax to be expected for the considered detectors Dᵢ; i.e., the following holds:
Oₛᵢ≠Oₛⱼ, when i≠j;
|Oₛᵢ−Oₛⱼ|>ΣᵢNᵢ^{max}
Oₛᵢ>ΣᵢNᵢ^{max}.

If, as given above in terms of an example, Nᵢ^{max}<20, then, for example, the desired values can be selected as follows: Oₛ₁=100, Oₛ₂=200 and Oₛ₃=300.

If a single detector Dᵢ is not operating properly, then the following holds for the magnitude |D| of the difference D:
|D|=|ΣᵢNᵢ−Oₛᵢ| and, thus,
Oₛᵢ=ΣᵢNᵢ^{max}<|D|<Oₛᵢ.

If detector D₁ is not working properly, then the magnitude |D| of the difference D lies, as a result, between 40 and 100. If detector D₂ is not working properly, then the magnitude |D| of the difference D lies, as a result, between 140 and 200. If detector D₃ is not working properly, then the magnitude |D| of the difference D lies, as a result, between 240 and 300.

Thus, on the basis of the magnitude |D| of the difference D, it is possible, unequivocally, to determine which Dᵢ is not working properly. The assigning of the magnitude |D| of the difference D to the affected detector Dᵢ assumes, however, that only a single detector Dᵢ is not working properly.

If one would want also to determine in the case of two detectors Dᵢ and Dⱼ not working properly, which detectors Dᵢ, Dⱼ these are, then the following must additionally hold for the desired values Oₛᵢ, Oₛⱼ of the offsets Oᵢ, Oⱼ of every possible affected detector pair Dᵢ, Dⱼ:
Osi+Osj∉[Osk−ΣᵢNᵢ^{max}; Osk+ΣᵢNᵢ^{max}]

For instance, in the case of the above example, the desired values for the first, second and third detectors D₁, D₂, D₃ can be, for example, Oₛ₁=100, Oₛ₂=500 and Oₛ₃=1000, respectively.

If only one detector Dᵢ is not working properly, then the following holds for the magnitude |D| of the difference D:
|D|=|ΣᵢNᵢ−Oₛᵢ|, and, thus,
OₛᵢΣᵢNᵢ^{max}<|D|<Oₛᵢ.

If detector D₁ is not working properly, then the magnitude |D| of the difference D lies between 40 and 100. If detector D₂ is not working properly, then the magnitude |D| of the difference D lies between 440 and 500. If detector D3 is not working properly, then the magnitude |D| of the difference D lies between 940 and 1000.

If the detectors Dᵢ and Dⱼ are not working properly, then the following holds for the magnitude |D| of the difference D:
|D|=|ΣᵢNᵢ−Oₛⱼ−Oₛᵢ|, and, thus,
Oₛᵢ+Oₛⱼ−ΣᵢNᵢ^{max}<|D|<Oₛⱼ+Oₛᵢ.

If the detectors D₁ and D₂ are not working properly, then the magnitude |D| of the difference D lies between 540 and 600. If the detectors D₁ and D₃ are not working properly, then the magnitude |D| of the difference D lies between 1040 and 1100. If the detectors D₂ and D₃ are not working properly, then the magnitude |D| of the difference D lies between 1440 and 1500.

If none of the detectors D₁, D₂ and D₃ is working properly, then the magnitude |D| of the difference D lies between 1540 and 1600. Thus, in the defined example of an embodiment, also this last case can be recognized on the basis of the magnitude |D| of the difference D.

If more than three detectors are employed, then the method can be correspondingly expanded.

The superordinated unit 23 recognizes, on the basis of the difference D, the presence of an error and derives therefrom the status of the measuring device. In the simplest case, the status contains the information that all detectors Dᵢ are working properly, or at least one of these is not. Additionally, the status can, in the case of an error, contain the information as to which of the one or more detectors Dᵢ is not working properly.

In the presence of an error, the superordinated unit 23 produces an output signal reflecting the status, which is fed, for example, to a measuring device electronics 29, or to a process control location. The superordinated unit can also issue an error report and/or trigger an alarm.

If no error is present, then the difference D is positive. The superordinated unit recognizes this and produces a measurement signal M on the basis of the sum signal. In the simplest case, the measurement signal corresponds to the difference D. When all detectors are working properly, this difference is positive and equal to the sum of the individual pulse rates Nᵢ of the individual detectors Dᵢ:
D=G−ΣᵢOₛᵢ=ΣᵢNᵢ

On the basis of this measurement signal, the physical variable to be measured, e.g. a fill level or a density of the filling substance, is determined. This can occur in conventional manner either by means of a measuring device electronics 29 integrated in the superordinated unit 23 or in a remotely located, evaluating unit 31.

If all detectors Dᵢ are working properly, the superordinated unit 23 can likewise issue an output signal reflecting the status. In this way, also the error-free working of the detectors Dᵢ can be indicated to, for example, the measuring device electronics 29, the evaluating unit 31 or to some other location, e.g. a process control location.

The superordinated unit 23 can be located in the last detector of a series; it can, however, also be arranged separately. The same holds for the measuring device electronics 29.

An advantage of the invention is that, due to the superimposing of the pulse rates Nᵢ and the offsets Oᵢ, and their transport together in the collector line 21, only a single connecting line, namely the collector line 21, is required for transmitting both the actual measurement information and also the status information. This reduces the required wiring effort considerably. Especially in safety-relevant regions, in which radiometric measuring devices are usually applied, e.g. in regions with increased danger of explosion, there are high safety demands placed on connecting lines, with which, as a rule, are associated increased procurement and installation costs. These costs are markedly reduced by the radiometric measuring devices of the invention. The collector line 21 can be a very simple connection, e.g. a light wave conductor, e.g. an optical fiber, or a copper line. Likewise, it is possible to replace the collector line 21 with a radio connection.

The transmission can be done in very simple manner. Especially, no transmission protocol is needed. The transmission of the output signals of the individual detectors Dᵢ can, in fact, with appropriate calibration, be accomplished via any kind of pulse output directed to a corresponding pulse input of the superordinated unit 23.

FIG. 6 shows a further example of an embodiment of a radiometric measuring device of the invention. Since most of the features of this embodiment are the same as in the above-described example of an embodiment, only differences will be explained in more detail in the following.

Also here, detectors Dᵢ are provided, which serve for registering radiation passing through the container 3 and for producing an electrical pulse rate Nᵢ corresponding to the registered radiation. Each detector Dᵢ includes an offset generator 19, which superimposes on the pulse rate Nᵢ of the pertinent detector Dᵢ a detector-specific offset O_{di}. In contrast to the above example of an embodiment, here the offsets O_{di} are detector-specific and independent of the status of the pertinent detector Dᵢ.

Each detector Dᵢ includes a turn-off switch 33, which serves for suppressing transmission of the pulse rate Nᵢ and the offset O_{di}, when the detector Dᵢ is malfunctioning. Turn-off switch 33 is, for example, a simple switch, which interrupts the connection of the pertinent detector Dᵢ to the collector line 21. Turn-off 33 switch can, however, also be integrated in the output stage 20 of the microcontroller 17.

During operation, therefore, only every properly working detector Dᵢ feeds an output signal, corresponding to the superimposing of the pertinent pulse rate Nᵢ and the pertinent offset O_{di}, to the collector line 21. Non-properly working detectors Dᵢ, in contrast, issue no output signal.

The collector line 21 feeds, as also the case in the above-described example of an embodiment, a sum signal, corresponding to the superimposing of the output signals, to the superordinated unit 23. This derives, as already described in connection with the above example of an embodiment, a measurement signal and/or a status of the measuring device on the basis of the sum signal.

With appropriate choice of the detector-specific offsets O_{di}, it is possible here, exactly as in the case of the example of an embodiment described above, to recognize, which of one or more detectors is not working properly. Additionally, a remainder count rate R can be determined, which is equal to the sum of the count rates Nᵢ of the properly-working detectors Dᵢ.

Such is equal to the difference between the total count rate G and the sum of the offsets O_{di} of the properly working detectors Dᵢ. If, for example, the detector Dₓ is not working properly, then the following holds:
R=G−Σ_{i,i≠x}O_{di}

From this, as required, helpful additional information can be derived. As an example, only a fill level measurement with two detectors is treated, such as is illustrated in FIG. 1. If one of the detectors D₁, D₂ fails, then it is possible, on the basis of the count rate Nᵢ of the remaining detector, to determine whether filling substance 1 is located in the region of the container 3 covered by the remaining detector. This rudimentary fill level information can be used e.g. for safety-directed control of a filling or emptying of the container 3. For instance, an overfilling or complete emptying of the container can be prevented.

Alternatively to the form of embodiment presented in FIG. 6, the detectors Dᵢ can also be so constructed, that a turn-off switch 35 only suppresses the superimposing of the detector-specific offset O_{di}, when the relevant detector Dᵢ is not working properly. This is shown in FIG. 7. If the detector Dᵢ is not working properly, the addition of the offset O_{di} is suppressed by the turn-off switch 35. This is represented in FIG. 7 by the feeding of the signals of offset generator 19 and turn-off switch 35 through a switch V. This combination of offset generator 19 and turn-off switch 35 forms, in effect, an offset generator, which issues a status-dependent offset. The sum signal is used in this case exactly as in the case of the example of an embodiment explained on the basis of FIG. 5.

FIG. 8 presents an example of an embodiment, wherein the measuring device has two detectors, namely a first detector Dᵢ and a second detector D₂. The measuring device is mounted at the container 3 fillable with the filling substance 1. The radioactive source 5 sends radioactive radiation through the container 3 during operation. The first and second detectors D₁ and D₂ serve for registering radiation passing through the container 3 and for producing electric pulse rates N₁, N₂ corresponding to the registered radiation.

The first detector D₁ has an offset generator, which superimposes on the pulse rate N₁ of the first detector D₁ an offset O₁ reflecting the status of the first detector D₁.

This is accomplished, for example, exactly as in the case of the example of an embodiment described with respect to FIG. 5.

Also here, a superordinated unit 23 is provided, integrated in the second detector D₂. The first detector D₁ is connected via a connecting line 37 with the superordinated unit 23, via which the first detector D₁ feeds an output signal corresponding to the superimposing of the pulse rate N₁ and the offset O₁. The connecting line 37 is connected for this purpose to a first input 39 of the superordinated unit 23.

Additionally fed to the superordinated unit 23 are the pulse rate N₂ and the status of the second detector D₂.

To this end, the second detector D₂ can be equipped, exactly as in the case of the first detector D₁, with an offset generator 19, which superimposes on the pulse rate N₂ an offset O₂ reflecting the status of the second detector D₂. An output signal corresponding to this superimposing lies then on a second input 41 of the superordinated unit 23.

Alternatively, the superordinated unit 23 can register the status information directly via a third input 43. The second detector then, in the case of this variant of embodiment, does not have an offset generator 19. Thus, FIG. 8 shows both the offset generator 19 of the second detector D₂ and the alternatively provided, third input 43.

The superordinated unit derives, on the basis of the incoming signals, a measurement signal and/or a status of the measuring device.

This happens, analogously to the examples of embodiments described above, by assigning to the offsets O₁ and, as required, O₂, desired values Oₛ₁, Oₛ₂, which the respective offset O₁, O₂ assumes, when the associated detector D₁, D₂ is working properly. If a detector D₁, D₂ is not working properly, then, for example, no offset is superimposed.

Since the superordinated unit 23 is integrated in the second detector D₂, the information of the detectors D₁ and D₂ can be processed separately via the inputs 37, 39, and, as required, 41, without other lines running outside of the detectors being required in addition to the connecting line 37.

This offers the advantage that the desired values Oₛ₁ and, as required, Oₛ₂ must only be greater than the maximum pulse rate Nᵢmax expected for the pertinent detectors D₁, D₂, but, by all means, can be smaller than the sum of the maximum expected pulse rate N₁^{max}+N₂^{max}. This improves the accuracy of measurement.

On the basis of the output signal of the first detector D₁, the superordinated unit 23 determines a count rate Z₁, which is equal to the sum of the pulse rate N₁ and the offset O₁. Then, the difference between this count rate Z₁ and the desired value Oₛ₁ for the offset O₁ of the first detector is formed. If the difference is positive, then detector D₁ is working properly and the magnitude of the difference is equal to the pulse rate N₁ of the first detector D₁. If the difference is negative, then the superordinated unit 23 recognizes that detector D₁ is not working properly.

In the case of the variant of the embodiment, in which the second detector D₂ is likewise equipped with an offset generator 19, the second detector D₂ is used in an analogous manner, i.e. the superordinated unit 23 determines, on the basis of the output signal of the second detector D₂, a count rate Z₂, which equals the sum of the pulse rate N₂ and the offset O₂. Then, the difference between this count rate Z₂ and the desired value Oₛ₂ for the offset O₂ of the second detector D₂ is formed. If the difference is positive, then detector D₂ is working properly and the magnitude of the difference is equal to the pulse rate N₂ of the second detector D₂. If the difference is negative, then the superordinated unit 23 recognizes that the detector D₂ is not working properly.

In the case of the alternative variant of the embodiment, in which the status information is separately transmitted, the superordinated unit recognizes directly on the basis of the signal lying on the third input 43, whether the second detector D₂ is working properly. Further, it determines, on the basis of the output signal of the second detector D₂ incoming on the second input 41, a count rate Z₂, which equals the pulse rate N₂ of the second detector D₂.

In the case of both variants, the status of the first and second detectors then is present in the superordinated unit 23.

If both detectors D₁, D₂ are working properly, then the pulse rates N₁ and N₂ are present in the superordinated unit 23. Simple addition of the pulse rates N₁ and N₂ leads to a measurement signal, which corresponds to the radiation registered by the two detectors D₁ and D₂. Additionally, the measurement information of each individual detector D₁, D₂ is available on the basis of the individual pulse rates N₁, N₂. If only one of the detectors D₁ or D₂ is working properly, this additional information can be separately used, as already explained above.

FIG. 9 shows a further example of an embodiment of a measuring device of the invention. Its construction corresponds, for the most part, to the example of an embodiment presented in FIG. 8. Therefore, only the differences will be explained in detail in the following.

In the case of the example of an embodiment presented in FIG. 9, the source 5 has a strength, at which a minimum pulse rate Nᵢ^{min} greater than zero is always to be expected for each detector D₁, D₂.

The first detector D₁ is connected via the connecting line 37 to the first input 39 of the superordinated unit 23 integrated in the second detector D₂, while the second detector D₂ is directly connected to its second input 41. In contrast to the example of an embodiment illustrated in FIG. 8, no offset generators 19 and no third input 43 are provided.

Instead, in each detector D₁, D₂, a turn-off switch 45 is provided, which suppresses the transmission to the superordinated unit of an output signal corresponding to the pulse rate N₁, N₂ of the pertinent detector D₁, D₂, when such detector D₁, D₂ is malfunctioning.

The signals of the detectors D₁ and D₂ fed to the superordinated unit 23 thus correspond to the pulse rates N₁, N₂ of the detectors D₁, D₂, when such are working properly.

The superordinated unit 23 has, preferably, a first counter, which counts the pluses n₁ incoming at the first input 39 and a second counter, which counts the pulses n₂ incoming at the second input 41, and determines the count rates Z₁, Z₂ of the incoming pulses n₁, n₂. If a count rate Z₁, Z₂ is zero pulses per time interval, then the superordinated unit 23 recognizes that the associated detector D₁, D₂ is not working properly. From this, the status of the measuring device is derived, and a corresponding status information is made available. The status information contains the statement that both detectors D₁ and D₂ are working properly, when both count rates Z₁ and Z₂ are different from zero. For the case that one or both count rates Z₁, Z₂ equal(s) zero, it contains the information that the measuring device is not working properly. Additionally, the status information can contain data concerning which of the detectors D₁, D₂ is not working properly, or whether both of the detectors D₁, D₂ are not working properly.

The status information is provided via an output 47 of the superordinated unit 23. Output 47 is preferably the only output of the second detector, as well as the only output of the measuring device. On the basis of the status information, an alarm can, for example, be triggered.

If both count rates Z₁ and Z₂ are different from zero, then both detectors D₁ and D₂ are working properly, and the superordinated unit 23 derives a measurement signal. This is based on the sum of the count rates, Z₁+Z₂, which, in this case, is equal to the sum of the pulse rates N₁+N₂ of the detectors D₁ and D₂. The measurement signal can, in such case, be a signal, which reflects the sum of the pulse rates N₁+N₂. The measurement signal is then, for example, fed to a measuring device electronics 29 or to a separate evaluating unit 31, which determines, on the basis of the measurement signal, the variable to be measured with the measuring device, e.g. a fill level or a density. The measuring device electronics 29 is, for example, likewise arranged in the second detector D₂.

Alternatively, an evaluation and/or processing of the pulse rates N₁+N₂ can also occur in the superordinated unit 23.

Status and/or measurement signal is/are available via the output 47.

In the case of all measuring devices of the invention, a single collector line, or a single connecting line, suffices for transmitting both the status and also the actual measurement information.

Each detector Dᵢ can, naturally, only transmit its status to the superordinated unit 23, when the status has already earlier been determined. In the technology of measurements, a series of methods for control and/or monitoring of the proper functioning of detectors are known.

An example, in this connection, is the control and/or monitoring of the energy, or power, supply of the detectors or individual detector components.

Further, it is possible, in the case of the described detectors Dᵢ, to check the optical coupling between the scintillator 7 and the photomultiplier 11.

To this end, e.g. reference light flashes are sent continuously through the scintillator 7 via the light conductor 49. Independently of whether the scintillator 7 is subjected to gamma radiation, or not, reference pulses must, due to the reference light flashes, be present on the output of the photomultiplier 11. If this is not the case, then the pertinent detector Dᵢ is not working properly.

In the case of measuring devices of the invention, in which the detectors Dᵢ include offset-generators 19, which superimpose on the pulse rate Nᵢ an offset Oᵢ dependent on the status of the pertinent detector Dᵢ, the status determination occurs, preferably, in the manner illustrated in FIG. 10, in that the offset generators 19 of the detectors Dᵢ are connected to the scintillator 7 via light conductors 49. During operation, the offset generators 19 periodically produce reference light flashes I and send these through the scintillator 7.

Preferably, the frequency fᵢ, with which the reference light flashes are emitted, equals the initially described, desired value Oₛᵢ for the offset Oᵢ of the pertinent detector Dᵢ. If the detector Dᵢ is working properly, then, on the output, there is a signal which corresponds to the sum of the pulse rate Nᵢ and the desired value Oₛᵢ. If a disturbance is present, markedly fewer pulses are detected. If the pulse rate of the detected pulses falls beneath the desired value Oₛᵢ, then this leads to a negative difference D.

An advantage of the invention is that, in the case of all radiometric measuring devices of the invention, only a single connection, namely the connector line 21, or the connecting line 37, as the case may be, is needed, in order to transmit both the actual measurement information as well as also the status information. This reduces the required wiring effort considerably. Especially in safety-relevant areas, in which radiometric measuring devices are usually applied, e.g. in areas with increased danger of explosion, there are high safety demands on connecting lines, with which are associated, as a rule, increased procurement and installation costs. These costs are markedly reduced by the radiometric measuring devices of the invention. This can be a very simple connection, e.g. a light wave conductor or a copper line. Likewise is it possible to embody the connection as a radio connection.

The transmission can be done in very simple manner. Especially, no transmission protocol is needed. The transmission of the output signals of the individual detectors Dᵢ can, in fact, occur, in the case of appropriate calibration, via every kind of pulse output to a corresponding pulse input of the superordinated unit 23.

1-10. (canceled)

11. A radiometric measuring device for mounting at a container fillable with a filling substance, comprising:
a radioactive source, which, in operation, sends radioactive radiation through the container;
at least two detectors, which serve for registering radiation passing through the container and for producing an electrical pulse rate corresponding to the registered radiation;
offset generators, which superimpose on the pulse rate of each detector an offset representing a status of such detector;
a collector line, to which each detector feeds an output signal corresponding to the superimposing of its pulse rate and its offset; and
a superordinated unit, which is fed by said collector line, a sum signal corresponding to the superimposing of the output signals, with said superordinated unit deriving, on the basis of the sum signal, a measurement signal and/or a status of the measuring device.

12. A radiometric measuring device for mounting at a container fillable with a filling substance, comprising:
a radioactive source, which, in operation, sends radioactive radiation through the container;
at least two detectors, which serve for registering radiation passing through the container and for producing an electrical pulse rate corresponding to the registered radiation;
offset generators, which superimpose on the pulse rate of each detector a detector-specific offset;
turn-off switches, which serve for suppressing transmission of pulse rate and offset, when a detector malfunctions;
a collector line, to which each properly working detector feeds an output signal corresponding to the superimposing of its pulse rate and its offset; and
a superordinated unit, which is fed by said collector line a sum signal corresponding to the superimposing of the output signals, with said superordinated unit deriving, on the basis of the sum signal, a measurement signal and/or a status of the measuring device.

13. The radiometric measuring device as claimed in claim 11, wherein:
a series of detectors is provided; and
said collector line begins at a first detector of the series, leads from there from one detector to the detector neighboring such, and from the last detector to said superordinated unit.

14. The radiometric measuring device as claimed in claim 11, wherein:
each detector comprises a scintillator and a photomultiplier appended thereto.

15. The radiometric measuring device as claimed in claim 14, wherein:
said offset-generators send periodic reference light flashes through said scintillator via a light conductor.

16. The radiometric measuring device as claimed in claim 13, wherein:
said superordinated unit is integrated in the last detector of the series.

17. The method for measuring a physical variable with a radiometric measuring device, comprising the steps of:
assigning a desired value for an offset to each detector, the offset generators of the detectors generating the desired value, when the detector is working properly, and the desired value is greater than the sum of the maximum expected pulse rates for the detectors;
determining a total count rate on the basis of the sum signal using the superordinated unit forming the difference between the total count rate and a count rate corresponding to the sum of the desired values of the offsets;
recognizing that an error is present, when the difference is negative; and
deriving a measurement signal in the case of positive difference.

18. The method for measuring a physical variable as claimed in claim 17, wherein:
in the case of a negative difference, it is determined on the basis of a mathematical method (e.g. difference), which of the detectors is malfunctioning.

19. A radiometric measuring device for mounting at a container fillable with a filling substance, comprising:
a radioactive source, which, during operation, sends radioactive radiation through the container;
first and second detectors, which serve for registering radiation passing through the container and for producing an electric pulse rate corresponding to the registered radiation;
an offset-generator, which superimposes on the pulse rate of the first detector an offset reflecting a status of the first detector; and,
a superordinated unit integrated in the second detector, with which the first detector is connected via a connecting line, via which the first detector feeds an output signal corresponding to the superpositioning of the pulse rate and the offset, to which the pulse rate and a status of the second detector are fed, and which, on the basis of the incoming signals, derives a measurement signal and/or a status of the measuring device.

20. A radiometric measuring device for mounting at a container fillable with a filling substance, comprising:
a radioactive source, which, during operation, sends radioactive radiation through the container,
first and second detectors, which serve for registering radiation passing through the container and for producing an electric pulse rate corresponding to the registered radiation and for transmitting an output signal corresponding to the pulse rate to a superordinated unit, wherein:
said radioactive source has a strength, in the case of which, for each detector, always a minimum pulse rate greater than zero is to be expected, wherein:
in each detector, a turn-off switch is provided, which suppresses transmission of the output signal to said superordinated unit, when the detector is malfunctioning; and
said superordinated unit derives a measurement signal and/or a status of the measuring device on the basis of the output signals.
